(19) United States
(12) Patent Application Publication
(10) Pub. No.: US 2007/0197276 A1
(43) Pub. Date: Aug. 23, 2007

(54) GAMING MACHINE

(75) Inventor: Kazunobu SATO, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/675,765

(22) Filed: Feb. 16, 2007

(30) Foreign Application Priority Data
Feb. 20, 2006 (JP) 2006-042401

(51) Int. Cl. A63F 9/24; G06F 19/00; A63F 13/00

(52) U.S. Cl. 463/16

(57) ABSTRACT

If the procedure is shifted to the treasure bonus process, twenty three treasure boxes are displayed on the lower display. Here, if the player selects desired treasure box by operation of the additional bet operating portion, the award corresponding to the treasure box is notified gradually based on the number of times of notification selection and the notification pattern thereof. If the predetermined condition is met in the treasure bonus process, the selection of the special treasure box becomes selectable.

### CROSS-REFERENCE TO RELATED APPLICATIONS

This application is based upon and claims a priority from the prior Japanese Patent Application No. 2006-42401 filed on Feb. 20, 2006, the entire contents of which are incorporated herein by reference.

### BACKGROUND

1. Technical Field

Aspects of the present invention relate to a gaming machine that provides a game that awards a payout in accordance with a selection item selected by a player.

2. Description of Related Art

In some conventional gaming machines, such as slot machines, when a player selects one selection item among a plurality of displayed selection items and the payout of the selected item corresponds to a bonus game, the bonus game is executed.

In one example, if the game mode advances to the bonus game, thirty panels, which form a 6 (wide)×5 (long) rectangular grid, are displayed on a display device. Either a symbol that indicates payout to a player or a symbol that indicates the end of the bonus game (referred to as an end-symbol) is associated with each of the panels. Consequently, in the bonus game of this example, the player repeatedly selects new panels until the end-symbol panel is selected. Here, the bonus game awarding payout executes until the end-symbol is displayed on the selected panel.

However, in the present example, if one panel is selected, the payout corresponding to selected panel will be awarded at once. That is, while simple actions such as selecting a panel and receiving the payout are repeated, the player does not receive any information from the system during that time. In this regard, the player receives little information while performing simple actions. As a result, the player may begin to feel that the game is monotonous. Further, when played for a long time, the player may randomly (or with some level of vagueness) select a given panel due to less critical thinking needed by the player. This may be due to less tension created by the game to select one panel over another. At the result, the game causes the player to experience less feelings of immediacy or anticipation, thereby leading to a reduction in the attraction for the slot machine. In slot machines in general, the player wants to win high payouts. However, with less information available and the player leaving panel selection (and the selection of payout amount) to chance, this example of slot machines is not favorable for the player who desires to win high payouts.

### SUMMARY

In view of the foregoing, one or more aspects of the present invention relate to a game, gaming machine, method of operating a game, or the like that awards a bonus game in accordance with a selection by a player, where the bonus game includes providing the player with award information. Also, in one or more aspects, the game may be enhanced by providing award information related to various possible selections under one or more conditions. Further, one or more examples of the invention may or may not include a processor that controls a game as described above. Moreover, in at least one example, the processor may further control the game such that the processor a) may set a notification pattern with one or plural stages corresponding to each of the first items, b) may permit notification of the award information on a condition that an additional bet is conducted after a game is started, and/or c) notify the award information corresponding to the selected item identified by the selection device according to the notification pattern when the condition is satisfied.

One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing a slot machine in a first illustrative embodiment in accordance with one or more aspects of the present invention.

FIG. 2 is a perspective view showing nine variable display portions of the slot machine in the first illustrative embodiment in accordance with one or more aspects of the present invention.

FIG. 3 is a perspective view showing eight pay lines of the slot machine in the first illustrative embodiment in accordance with one or more aspects of the present invention.

FIG. 4 is a block diagram schematically showing a control system of the slot machine in the first illustrative embodiment in accordance with one or more aspects of the present invention.

FIG. 5 is a block diagram schematically showing a display drive circuit of the slot machine in the first illustrative embodiment in accordance with one or more aspects of the present invention.

FIG. 6 is a view showing a symbol row (video reel) variably displayed while being scrolled in each of the variable display portions on a lower display in the first illustrative embodiment in accordance with one or more aspects of the present invention.

FIG. 7 is an explanatory view showing a lottery table to determine the symbols stopped and displayed in nine variable display portions in accordance with one or more aspects of the present invention.

FIG. 8 is an explanatory view showing payout table to indicate the winning combinations and payouts corresponding thereto in one or more embodiments in accordance with one or more aspects of the present invention.

FIG. 9 is a flowchart showing a main process program in first illustrative embodiment in accordance with one or more aspects of the present invention.

FIG. 10 is a flowchart showing other game process program in first illustrative embodiment in accordance with one or more aspects of the present invention.

FIG. 11 is a view showing an illustrative example in which each of the “PEARL” symbols is displayed in three variable display portions on the lower display in accordance with one or more aspects of the present invention.

FIG. 12 is a view showing contents displayed on the lower display, in a shell chance game in accordance with one or more aspects of the present invention.

FIG. 13 is an explanatory view showing a table used to determine each of the contents of the shells, in the shell chance game in accordance with one or more aspects of the present invention.

FIG. 14 is a view showing an example in which the contents of each shell are displayed, in the shell chance game.

FIG. 15 is a flowchart showing a treasure bonus process program in the illustrative embodiment in accordance with one or more aspects of the present invention.

FIG. 16 is a view showing contents displayed on the lower display in the treasure bonus game in accordance with one or more aspects of the present invention.

FIG. 17 is a view showing an example in which numbering for each treasure box is conducted in the treasure bonus game in accordance with one or more aspects of the present invention.

FIG. 18 is a view showing contents displayed on the upper display, in the treasure bonus game in accordance with one or more aspects of the present invention.

FIG. 19 is a view showing an example in which numbering for each special treasure box is conducted in the special treasure bonus game in accordance with one or more aspects of the present invention.

FIG. 20 is an explanatory view showing a lottery table used to determine each of the awards of each of the treasure boxes, in the treasure bonus game in accordance with one or more aspects of the present invention.

FIG. 21 is an explanatory view showing a lottery table used to determine the existence or nonexistence of the “CLOWNFISH” of each treasure boxes in the treasure bonus game in accordance with one or more aspects of the present invention.

FIG. 22 is an explanatory view showing a notification pattern table used in the notification pattern determination process in accordance with one or more aspects of the present invention.

FIG. 23 is an explanatory view showing a specific example in which the contents stored in the RAM 52 when the notification pattern process (S23) is finished in accordance with one or more aspects of the present invention.

FIG. 24 is an explanatory view an example in which the display of the award of the selected treasure bonus in the treasure bonus game in accordance with one or more aspects of the present invention.

FIG. 25 is a flowchart showing an award notifying process program in first illustrative embodiment in accordance with one or more aspects of the present invention.

FIG. 26 is an explanatory view showing a relation notification pattern and the number of times of notification selection in first illustrative embodiment in accordance with one or more aspects of the present invention.

FIG. 27 is a flowchart showing an award notification process program in accordance with one or more aspects of the present invention.

FIG. 28 is an explanatory view showing an special award lottery table in first illustrative embodiment in accordance with one or more aspects of the present invention.

FIG. 29 is an explanatory view showing a memory content in the RAM 52 when the notification pattern determination process (S52) in accordance with one or more aspects of the present invention.

FIG. 30 is an explanatory view showing a display content on the lower display 4 when the special award notification process is executed in accordance with one or more aspects of the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

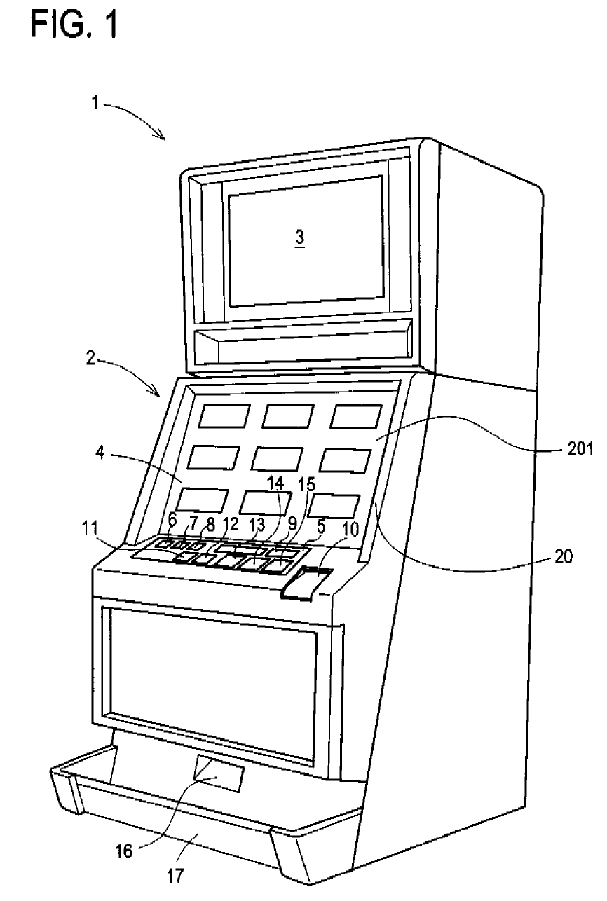

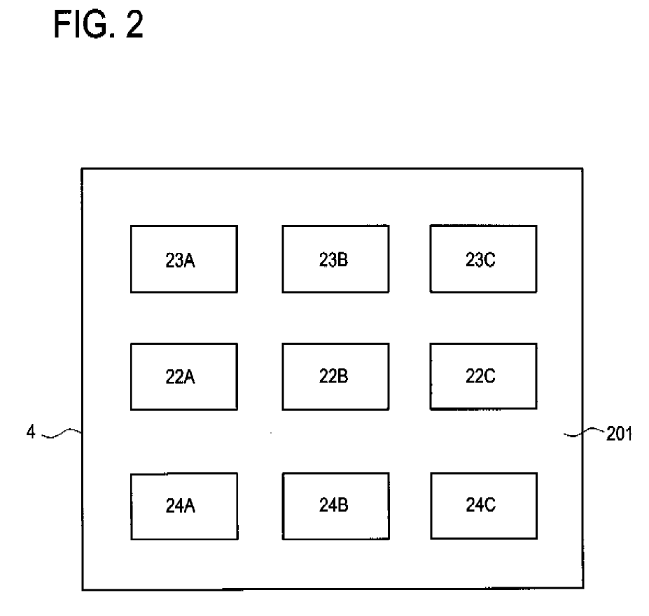

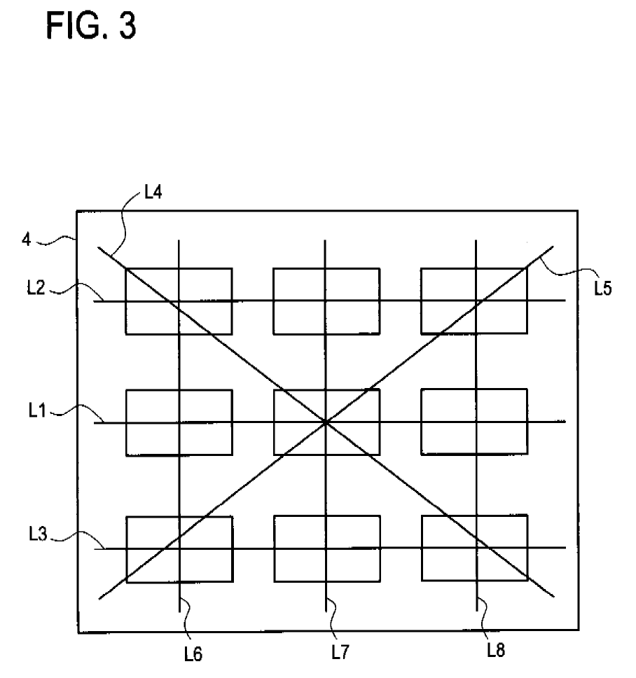

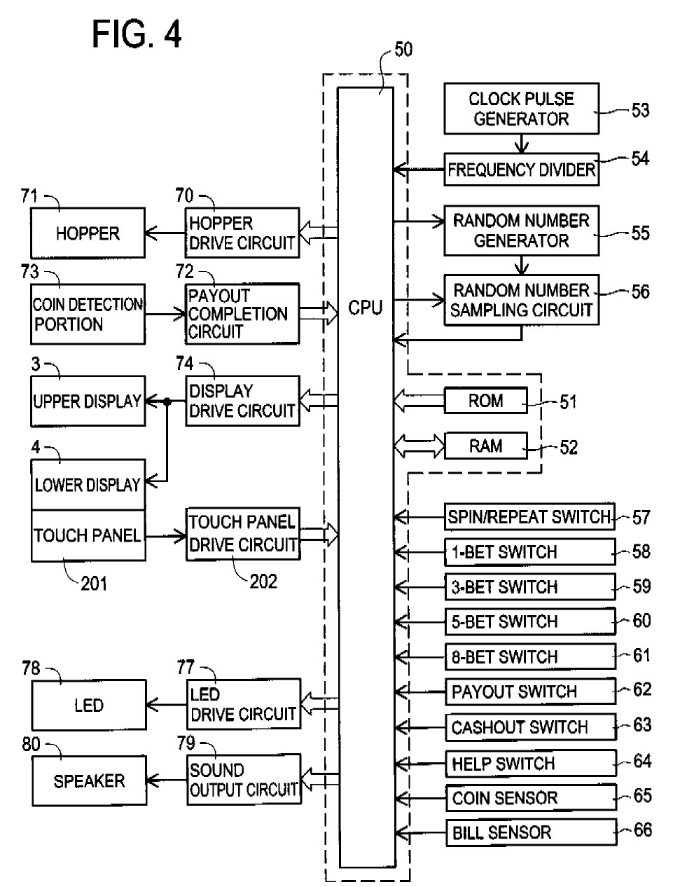

At first, the construction of the slot machine according to one or more embodiments will be described with reference to FIGS. 1 to 4. FIG. 1 is a perspective view showing a slot machine. FIG. 2 is a perspective view showing nine variable display portions. It is appreciated that the number of variable display portions may be other values as well (including but not limited from two to twenty five, for instance). FIG. 3 is a perspective view showing eight pay lines. Here again, the number of pay lines is variable. FIG. 4 is a block diagram showing an example of a control system of the slot machine.

As shown in FIG. 1, a slot machine 1 has a cabinet 2 forming the whole. An upper display 3 is positioned in the upper front part of the cabinet 2, and a lower display 4 is positioned on a device front panel 20 positioned in the front center part of the cabinet 2. Displays 3 and 4 may be CRTs, liquid crystal displays, plasma displays, LED displays, OLED displays, and other known display technologies. For instance, one or both the upper display 3 and the lower display 4 may be liquid crystal displays. A transparent touch panel 201 is positioned on the front surface of the lower display 4. Transparent touch panel 201 may form part or all of a selection device. It is appreciated that other structures may be used in place of touch panel 201 including buttons and the like. The term “selection device” encompasses various structures that permit a user to select an item. It is appreciated that CRTs and other display technologies may be used in place of or in conjunction with the displays 3 and 4. Further, in some aspects, the upper display 3 and the lower display 4 may be combined into a single display or further separated into three or more displays.

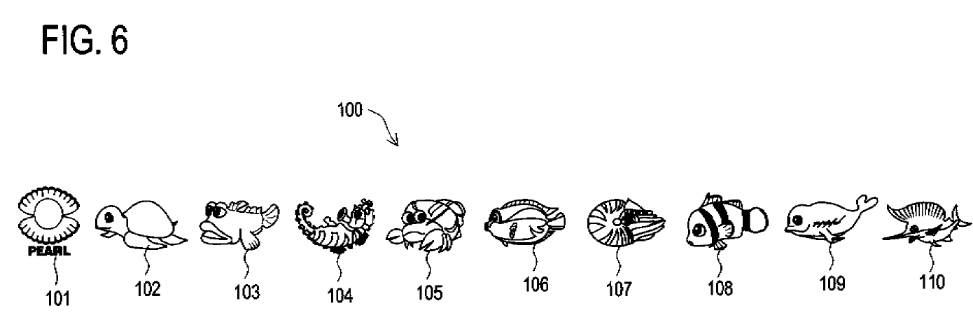

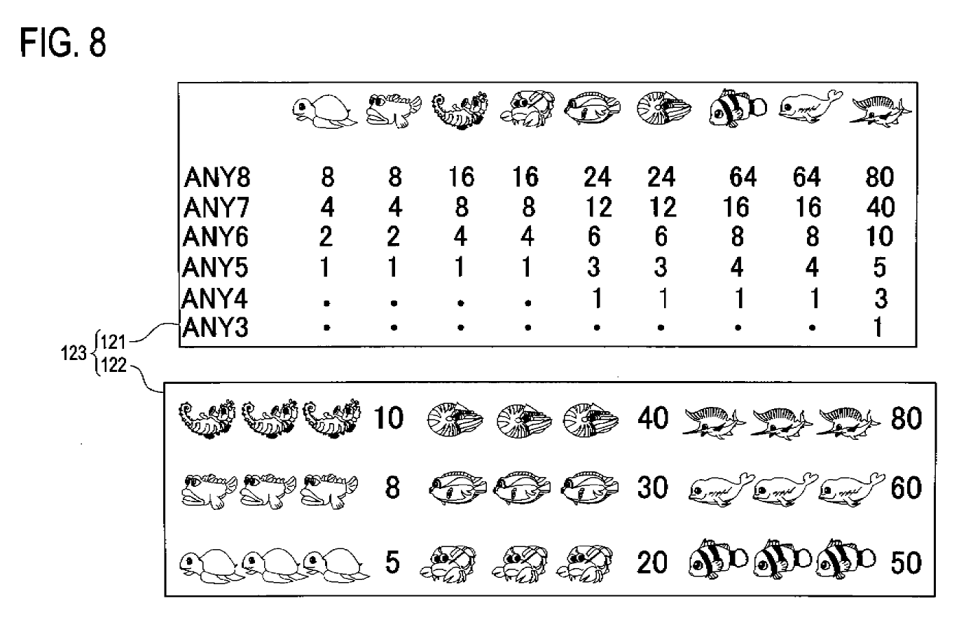

The upper display 3 displays information on a game such as a game method, a payout table 123 indicating kinds of winning combinations and payouts corresponding thereto (see FIG. 8), and various effects on the game. On the other hand, the lower display 4 displays a number of variable display portions (for example, nine variable display portions) 22A to 22C, 23A to 23C, and 24A to 24C shown in FIG. 2. The lower display 4 displays a number of pay lines “L1” to “L8” (for example, eight pay lines) as shown in FIG. 3. Here, in each of the display portions 22A to 22C, 23A to 23C, and 24A to 24C, variable displays may be displayed as part or all of a video reel 100. That is, various kinds of symbols to form the video reel 100 (see FIG. 6) are displayed while being scrolled from the right to the left (or scrolling in other directions) in each of the display portions 22A to 22C, 23A to 23C, and 24A to 24C. Other types of displays may be used to display the display portions 22A to 22C, 23A to 23C, and 24A to 24C including but not limited to flashing, fading, wiping, and other transition techniques.

An operation table 5 formed by projecting to proximal side is provided at the bottom of the lower display 4. A CHANGE button 6, a CASHOUT button 7, and a HELP button 8 are arranged on the operation table 5 (for instance, arranged on the left side). A coin insertion slot 9 and a bill insertion portion 10 may be located to the right of the HELP button 8. A 1-BET button 11, a SPIN/REPEAT BET button 12, a 3-BET button 13, a 5-BET button 14, and an 8-BET button 15 may be arranged on the forward part of the operation table 5.

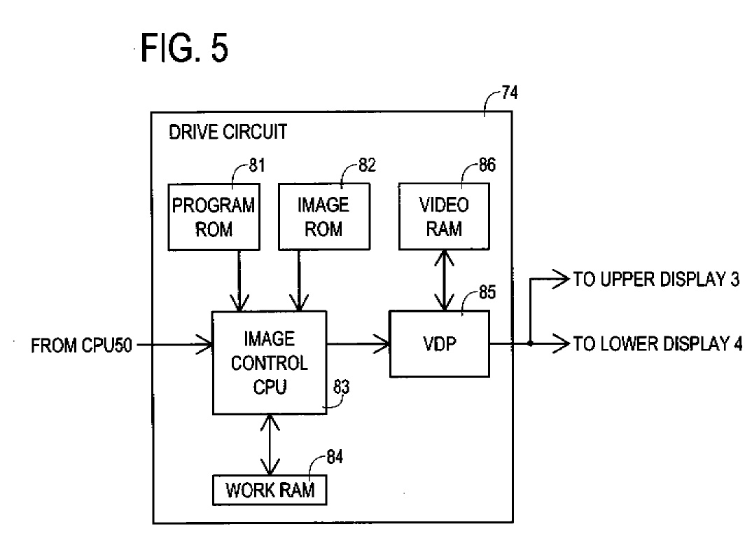

The CHANGE button 6 is a button to be pressed when the bill inserted in the bill insertion portion 10 is to be returned to a player in the form of one or more coins. Changed coins dispensed on the basis of a press operation of the CHANGE button 6 are paid out through a coin payout opening 16 to a coin tray 17, which may be formed at the lower part of the cabinet 2. A CHANGE switch 62, which will be described later, may be attached to the CHANGE button 6. Here, a switch signal, which is generated from the CHANGE switch 62, may be output to a CPU 50 on the basis of pressing the CHANGE button 6 as shown in FIG. 5.

After a game has ended, the CASHOUT button 7 is pressed to retrieve the player's remaining coins. When the CASHOUT button 7 is pressed, coins won in games are paid out through the coin payout opening 16 to the coin tray 16. A CASHOUT switch 63, which will be described later, is attached to the CASHOUT button 7. A switch signal, which is generated from the CASHOUT switch 63, may be output to the CPU 50 on the basis of pressing the CASHOUT button 7 (see FIG. 5).

The HELP button 8 is a button to be pressed when a player cannot understand game operation method. When the HELP button 8 is pressed, various help information is displayed on the upper display 3. A HELP switch 64, which will be described later, is attached to the HELP button 8.

A coin sensor 65, which will be described later, is arranged in relation to the coin insertion slot 9. When the coin (s) is inserted in the coin insertion slot 9, the coin sensor 65 detects coin (s) inserted and a coin detection signal, which is generated from the coin sensor 65, may be output to the CPU 50 (see FIG. 4).

A bill sensor 66, which will be described later, is arranged in relation to the bill insertion portion 10. When the bill is inserted in the bill insertion portion 10, a bill detection signal, which is generated from the bill sensor 66, may be output to the CPU 50 (see FIG. 4).

The 1-BET button 11 is a button to bet one bet every press of the 1-BET button 11. A 1-BET switch 58 is attached to the 1-BET button 11. In the slot machine 1 of the embodiment, all pay lines “L1” to “L8” are activated on the basis of one bet. If the 1-BET button 11 is pressed, a switch signal which is generated from the 1-BET switch 58, will be output to the CPU 50 (see FIG. 5).

A SPIN/REPEAT BET button 12 is a button to start the game with the present bet number or the previous bet number on the basis of a press of the button 12. If the SPIN/REPEAT BET button 12 is pressed, variable display of the symbols in each of the variable display portions 22A to 22C, 23A to 23C, and 24A to 24C will start. A spin switch 57, which will be described later, is attached to the SPIN/REPEAT BET button 12. Here, in one or more embodiments, the bet number, which can be betted by pressing of the SPIN/REPEAT BET button 12 can be any value including but not limited to one, two, three, five, or eight.

The 3-BET button 13, the 5-BET button 14, and the 8-BET button 15 are buttons to bet three, five, and eight bets on the basis of a press operation thereof. A 3-BET switch 59, a 5-BET switch 60, and an 8-BET switch 61 are attached to the 3-BET button 13, the 5-BET button 14, and the 8-BET button 15, respectively.

The coin payout opening 16 and the coin tray 17 may be formed at a lower position of the cabinet 2. The coin payout opening 16 is the portion in which coin (s) is paid on the basis of press operation of the CHANGE button 6 or the CASHOUT button 7. The coin tray 17 is the portion for receiving coins paid out from the coin payout opening 16. The coin detection portion 73, which is constructed from the sensor etc., is arranged inside the coin payout opening 16. The coin detection portion 73 detects the number of coins paid out from the coin payout opening 16 (see FIG. 4).

Next, the construction of the control system in the slot machine 1 will be described with reference to FIG. 4. FIG. 4 is a block diagram schematically showing the control system in the slot machine 1. As shown in FIG. 4, the control system in the slot machine 1 may be constructed from a CPU 50 as a core. A ROM 51 and a RAM 52 are connected to the CPU 50. In the ROM 51, various programs for controlling the slot machine 1 and data tables are stored. For example, various control programs including a main process program, which will be described later and various data tables (including a lottery table associating a value of a random number and a symbol to be displayed) may be stored in the ROM 51. The RAM 52 is a temporary memory for storing various data processed by the CPU 50.

A clock pulse generator 53 for generating standard clock pulses and a frequency divider 54 are connected to the CPU 50. Further, a random number sampling circuit 56 for generation random numbers are connected to the CPU 50. Here, the random numbers sampled by the random number sampling circuit 56 is used in various lotteries including the winning combinations. Further, switches attached every button on the operation table 5 are attached, respectively. That is, a SPIN/REPEAT switch 57, a 1-BET switch 58, a 3-BET switch 59, a 5-BET switch 60, an 8-BET switch 61, a CHANGE switch 62, a CASHOUT switch 63, and a HELP switch 64 are connected to the CPU 50, respectively. If the CPU 50 receives the switch signal output from each switch on the basis of press operation thereof, the CPU 50 will control various operations corresponding to the button in which the switch signal from thereof received.

Further, a coin sensor 65 and a bill sensor 66 are connected to the CPU 50, respectively. The coin sensor 66 detects coins inserted from the coin insertion slot 9. Herewith, the CPU 50 can calculate the number of inserted coins based on the coin detection signal output from the coin sensor 65. The bill sensor 66 detects the kind and sum of the bill inserted from bill insertion portion. The CPU 50 calculates the number of coins equal to the sum of bill based on that bill detection signal.

A hopper 71 is connected through a hopper drive circuit 7 to the CPU 50. If a drive signal, which is generated from the CPU 50, is output to the hopper drive circuit 70, the hopper 71 will pay out a predetermined number of coins from the coin payout opening 16. A coin detection portion 73 arranged in the coin payout opening 16 is connected to the CPU 50 through the payout completion signal circuit 72. If the coin detection portion 73 detects that a predetermined number of coins are paid out from the coin payout opening 16, a coin payout detection signal will be output to the payout completion signal circuit 72. The payout completion signal circuit 72 outputs a payout completion signal to the CPU 50 based on the coin payout detection signal. Further, the upper display 3 and the lower display 4 are connected through a the display drive circuit 74 to the CPU 50. Hence, the display contents of the upper display 3 and the lower display 4 are controlled by the CPU 50, respectively.

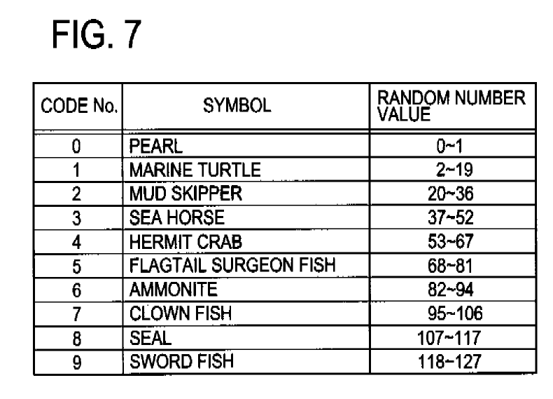

Here, as shown in FIG. 5, the display drive circuit 74 is constructed from a program ROM 81, an image ROM 82, an image control CPU 83, a work RAM 84, a VDP (video display processor) 85, and a video RAM 86. An image control program related to the display on the upper display 3 and the lower display 4, and various selection tables are stored in the program ROM 81. The image data to form images, for example, various images of the demonstration effects and the treasure bonus game displayed on the upper display 3 and the lower display 4, help information and the payout table displayed on the upper display 3 are stored in the image ROM 82. Here, in the image ROM 82, the image data to form images of the symbols displayed in the variable display portions 22A to 22C, 23A to 230C and 24A to 24C (see FIG. 2) on the lower display 4 are also stored. The symbols displayed in the variable display portions 22A to 22C, 23A to 23C, and 24A to 24C will be described later The image control CPU 83 determines the images displayed on the upper display 3 and the lower display 4 among the image data stored beforehand in the image ROM 82 according to the image control program stored beforehand in the program ROM 81 based on parameters set by the CPU 50. The work RAM 84 works as a temporary memory when the image control program is executed in the image control CPU 83. The VDP 85 forms images corresponding to display contents determined by the image control CPU 83, and the VDP 85 outputs the images formed thereby to the upper display 3 and the lower display 4. Thereby for example, each of the symbols of the video reel 100 shown in FIG. 7 is variably displayed and stopped in the variable display portions 22A to 22C, 23A to 23C, and 24A to 24C on the lower display 4. The video RAM 86 works as a temporary memory when the images are formed by the VDP 85.

The touch panel 201 is connected through a touch panel drive circuit 202 to the CPU 50. As mentioned above, the touch panel 201 is arranged on the image screen of the lower display 4. The CPU 50 can recognize the place where the player touches based on the coordinate information of the portion touched by the player based on the touch panel drive circuit 202.

LEDs 78 are connected through a LED drive circuit 77 to the CPU 50. Many LEDs 78 are arranged on the front face of the slot machine 1, and are controlled by the LED drive circuit 77. LEDs 78 are controlled based on the drive signal from the CPU 50 when various effects are produced. A sound output circuit 79 and a speaker 80 are connected to the CPU 50. The speaker 80 reproduces various effect sounds when various effects are produced based on the output signal from the sound output circuit 79.

Next, the symbols used in the game of the slot machine 1 will be described. FIG. 6 is a view showing a symbol row (video reel), which is variably displayed while being scrolled in each of the variable display portions 22A to 22C, 23A to 23C, and 24A to 24C. Here, the video reel 100 is constructed from the symbol row constructed from various symbols. For the purposes of explanations the various symbols may include “PEARL” 101, “MARINE TURTLE” 102, “MUDSKIPPER” 103, “SEAHORSE” 104, “HERMITCRAB” 105, “FLAGTAIL SURGEONFISH” 106, “AMMONITE” 107, “CLOWNFISH” 108, “SEAL” 109, and “SWORD FISH” 110.

As mentioned above, in the slot machine 1, in the variable display portions 22A to 22C, 23A to 23C, and 24A to 24C (for instance, nine), the symbols are variable displayed by the video reel 100, and one symbol is stopped and displayed in each of the variable display when the predetermined time elapses. Here, the lottery table, which is used when the symbols stopped and displayed in each of the variable display portions 22A to 22C, 23A to 23C, and 24A to 24C are determined, will be described with reference to FIG. 7. FIG. 7 is an explanatory view showing the lottery table of the stopped and displayed symbols used when the game is performed by using variable display portions. Here, the lottery table shown in FIG. 7 is stored in the ROM 51.

Stopped and displayed symbols in each of the variable display portions 22A to 22C, 23A to 23C, and 24A to 24C are determined every each variable display portion 22A to 22C, 23A to 23C, and 24A to 24C. Therefore, a code number, which lies in a range of “0” to “9” for instance, is allotted to each of the symbols to form the video reel 100 (see FIG. 6) (for instance, in order from the left). The lottery table (see FIG. 7) in which each of the code numbers is set for the range thereof is provided beforehand. Further, nine random numbers are sampled by the random number sampling circuit 56 so as to correspond to each of the variable display portions 22A to 22C, 23A to 23C, and 24A to 24C. At a result, the symbols which are stopped and displayed in each of the variable display portions 22A to 22C, 23A to 23C, and 24A to 24C are determined based on the code numbers.

It will be specifically described in this point. For example, in the case that the random number is sampled for each of the symbols to form the video reel 100 in the variable display portion 23A through the random number sampling circuit 56, if the random number lies in a range of 0 to 1, the code number of the variable display portion 23A is “0” based on the lottery table (see FIG. 7). Thereby, the symbol in which stopped and displayed in the variable display portion 23A is the “PEARL” symbol 101 corresponding to the code No. 0. Thereby, in this case, when scrolled display in which being done predetermined time is finished, the “PEARL” symbol 101 is stopped and displayed in the variable display portion 23A. Here, each of the symbols to form the video reel 100 in the variable display portion 23A will be described. As shown in the lottery table in FIG. 8, if the random number lies in a range of 0 to 1, the “PEARL” symbol 101 allotted to the code No. “0” is stopped and displayed in the variable display portion 23A. Below, each of the code numbers “1” to “9” is processed in the same way based on the lottery table (see FIG. 7).

Each of the symbols to form the video reel in the other variable display portions is determined as well as the symbol to form the video reel in the variable display portion 23A.

Next, the winning combinations and the payouts thereof in the slot machine 1 will be described with reference to FIG. 8. FIG. 8 is an explanatory view showing the payout table indicating the winning combinations and the payouts thereof. As shown in FIG. 8, the payout table 123 is constructed from any odds table 121 (providing odds for matching combinations of symbols) and a line odds table 122. Here, the payout table 123 is stored in table in the ROM 51.

The any odds table 121 holds a payout number every one symbol in accordance with the number of the same symbols stopped and displayed in the variable display portions (see FIG. 3) existing on the pay lines (see FIG. 2) displayed on the lower display 4. For example, concerning the variable display portions 22A to 22C, 23A to 23C, and 24A to 24C, if five code numbers corresponding to the variable displayed portions on the pay lines are any of “2” to “19” respectively “ANY-5 of MARINE TURTLE” is won (see FIG. 7). In this case, concerning with the variable display portions 22A to 22C, 23A to 23C, and 24A to 24C, five code numbers corresponding to the variable displayed portions are “2”, the “MARINE TURTLE” symbol is displayed and stopped, respectively. Here, the payout number “1” will be acquired (see FIG. 8) on the basis of that result of lottery. Similar to this, each of the payouts of any odds is determined based on the any odds table 121 shown in FIG. 8. Here, in the slot machine 1, in one or more embodiments, all pay lines (for instance, all eight pay line) are activated with one bet, so with respect to the variable display portions 22A to 22C, 23A to 23C, and 24A to 24C, it requires that five variable display portions are the same. However, in the embodiment in which activated pay lines are variable based on the bet number, it is determined whether or not any odds win based on the number of the same symbols in the symbols displayed in the variable display portions corresponding to the activated pay lines.

On the other hand, the line odds table 122 holds a payout number in which the same symbols are stopped and displayed in all variable display portions on some pay line (see FIG. 3) among each pay line (see FIG. 3) on the lower display 4. For example, concerning the variable display portions 22A to 22C, 23A to 23C, and 24A to 24C, if all code numbers for the variable display portions (for example, variable display portion 22A to 22C) on some pay line (for example, pay line L1) among pay lines are any of “2” to “19”, “MARINE TURTLE-MARINE TURTLE-MARINE TURTLE” is won (see FIG. 7) for this pay line (see FIG. 4). In this case, all code numbers of variable display portion on that pay lines are “2”, and the symbol “MARINE TURTLE” 102 is stopped and displayed in that variable portions (see FIG. 7). The payout number “5” will be acquired. Here, in a case where there exists plural pay lines for each of which “MARINE TURTLE-MARINE TURTLE-MARINE TURTLE” is won, the payout number calculated by multiplying the number of pay lines by “5” will be obtained. Similarly to this, each payout number of line-odds will be determined based on the line-odds table 122.

Here, concerning the variable display portions 22A to 22C, 23A to 23C, 24A to 24C, if code numbers for three or more variable display portions are “0” or “1”, the “PEARL” symbol 101 is respectively stopped and displayed (see FIG. 7). In this case, a shell chance game is executed on the lower display 4 based on the variable display portions 22A to 22C, 23A to 23C, and 24A to 24C, if the “PEARL” symbols 101 are stopped and displayed in three and more variable display portions. The shell chance game will be described later.

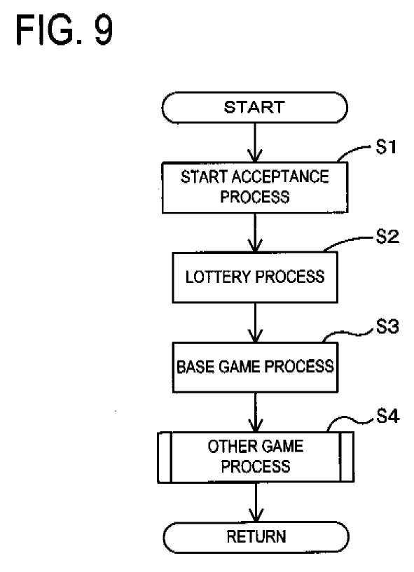

Next, the main process program executed in the slot machine 1 will be described with reference to FIG. 9. FIG. 9 is a flowchart showing the main process program. In FIG. 9, at first, in S1, the CPU 50 executes the start acceptance process. In this start acceptance process, the bet value in an ongoing game is determined, and the process to start the game is executed. Specifically, if the predetermined time (for example, fifteen seconds) elapses until the 1-BET button 11, the SPIN/REPEAT BET button 12, the 3-BET button 13, the 5-BET button 14, or the 8-BET button 15 (hereinafter “1-BET button or the like” as a generic term of above buttons) is operated, the CPU 50 will produce the demonstration effect on the upper display 3 and the lower display 4. Here, without relation to production of the demonstration effect, if the 1-BET button 11 or the like is operated, the CPU 50 will display the pay lines “L1” to “L8” on the lower display 4 based on the switch signal output from the switch corresponding to the operated button (for example, the 1-BET switch 58). Next, the payout table including the any odds table 121 and the line-odds table 122 (see FIG. 9) will be displayed on the upper display 3. The CPU 50 stores the bet value, which is bet on the basis of press operation of the 1-BET button 11 or the like to the RAM 52, and shifts the lottery process (S2).

After the procedure is shifted to the lottery process (S2), the CPU 50 determines each of the symbols to be stopped and displayed in each of the variable display portions 22A to 22C, 23A to 23C, and 24A to 24C, and executes the process to determine the winning combination. Specifically, random number values are sampled through the random number sampling circuit 56 in a range (where the range may be 0 to 127, for instance) so as to correspond to each of the variable display portions 22A to 22C, 23A to 23C, and 24A to 24C by the CPU 50. The stopped and displayed symbols in each of the variable display portions 22A to 22C, 23A to 23C, and 24A to 24C are determined by the code numbers based on the sampled random number values and lottery table (see FIG. 7). If each of the symbols stopped and displayed in each of the variable display portions 22A to 22C, 23A to 230, and 24A to 24C is determined, the CPU 50 will determine the winning combination (including any odds and line odds thereof) in the game and the payout thereof based on the symbol which is stopped and displayed in each of the variable display portions and the payout table 123 (see FIG. 8). In the lottery process (S2), if the winning combination and the payout thereof in the game are determined, the CPU 50 stores the result of lottery to the RAM 52, after that, the procedure is shifted to the base game process (S3).

In the base game process (S3), the video reels 100 are scrolled, stopped, and displayed in each of the variable display portions 22A to 22C, 23A to 23C, and 24A to 24C by the CPU 50. Further, in the base game process (S3) the payout based on the result of lottery in the lottery process (S2) will be paid to the player. Specifically, every symbol image to form a video reel 100 is displayed while being scrolled from the right to the left in each of the display portions 22A to 22C, 23A to 23C, and 24A to 24C by the CPU 50. If the predetermined time elapses since scrolling and display are started, the CPU 50 stops and displays the symbols respectively determined every variable display in each of the variable display portions based on the result of lottery in the lottery process (S2). After the symbols are stopped and displayed, the CPU 50 will pay the payout corresponding to the result of lottery in this game based on the symbols stopped and displayed on the each of the variable display portions 22A to 22C, 23A to 23C, and 24A to 24C and the payout table. At this time, if a plurality of any odds and/or line-odds is/are realized at the same time, coins corresponding to the sum obtained by totally adding up each of the payouts are paid out. After paying the payout in this game, the CPU 50 shifts the procedure to the other game process (S4).

In S14, the CPU 50 determines whether or not predetermined condition is met. If predetermined condition is met, the game including the shell chance game and treasure game, which will be described later, will be executed. In addition, the other game process (S4) will be described later, therefore description thereof will be omitted here. After the other game process (S4) is executed, the CPU 50 finishes the main process program. After that, the CPU 50 newly executes the main process program.

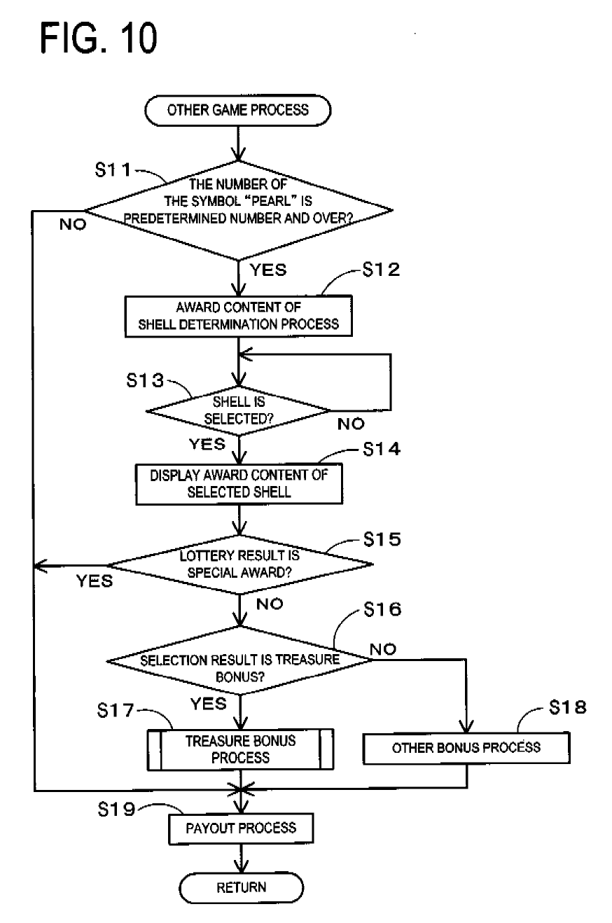

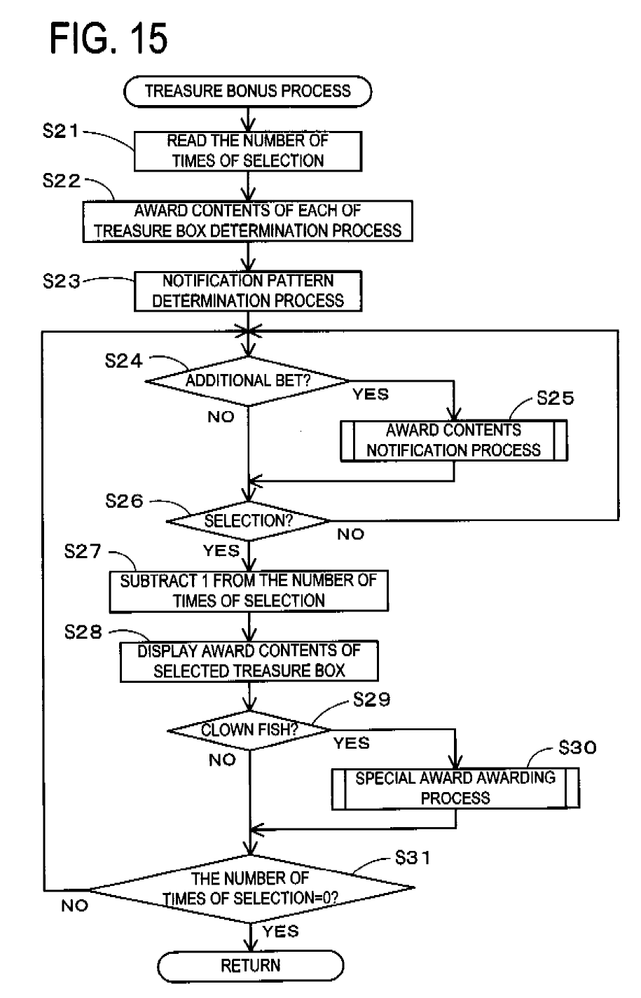

Next, the other game process program executed in the slot machine 1 will be described with reference to FIG. 10. FIG. 10 is a flowchart showing the other process program. If the procedure is shifted to the other game process (S4) after finishing the base game process (S3) in the main control process above, the CPU 50 determines whether or not the “PEARL” symbols 101 with a predetermined number or more are stopped and displayed in the variable display portion 22A to 22C, 23A to 23C, and 24A to 24C on the pay lines L1 to L8 displayed on the lower display 4. Here, the predetermined number of the “PEARL” symbols in the embodiment is set to three (see FIG. 15). If the number of the “PEARL” symbol is the predetermined number or more (S11: YES), the procedure will shift to S12 to be executed the shell chance game by the CPU 50. On the other hand, if the number of the “PEARL” symbol displayed is less than the predetermined number (S11: NO), the payout process (S19) will be executed by the CPU 50.

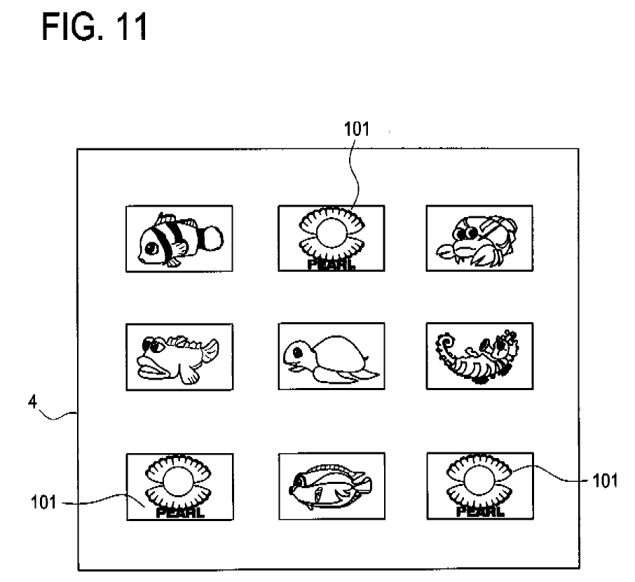

Here, the outline of the shell chance game process is described with relation to the drawings where the shell chance game process is executed if the “PEARL” symbol 101 with the predetermined number or more are stopped and displayed. As shown FIG. 11, pertaining to the variable display portions 22A to 22C, 23A to 23C, and 24A to 24C, if the “PEARL” symbols 101 are stopped and displayed in three variable display portions (In the case of FIG. 11, variable display portion 23B, variable display portion 24A, and variable display portion 24C), the shell chance game will be executed.

After the procedure is shifted to the shell chance game, at first, five shells 211 are displayed on the lower display 4 (see FIG. 12). Each of five shells is associated with the award awarding to the player respectively. Each of the shells 211 is respectively associated with any of “A”, “B (the number of times of selection: three times)”, “B (the number of times of selection: four times)”, “B (the number of times of selection: fine times)”, “10”, “20”, “30” by lottery. The game, in which if the shell is selected by the player, the player will acquire the award associated with the shell selected by the player, is executed.

Here, each of the contents of the award will be described. If the award of selected shell is “A”, the player can play the other game. Here, the other game is the bonus game executed in S18 which will be described later. The content of the other game is allowed such as, for example, a free game without credit consumption. If the award of selected shell is any of “B (the number of times of selection: three times)”, “B (the number of times of selection: four times)”, or “B (the number of times of selection: five times)”, the player can play the treasure bonus game. The content of the treasure bonus game will be described later. On the other hand, if the award of selected shell is any of “10”, “20”, or “30”, the player can acquire the payout of the selected shells as the special award.

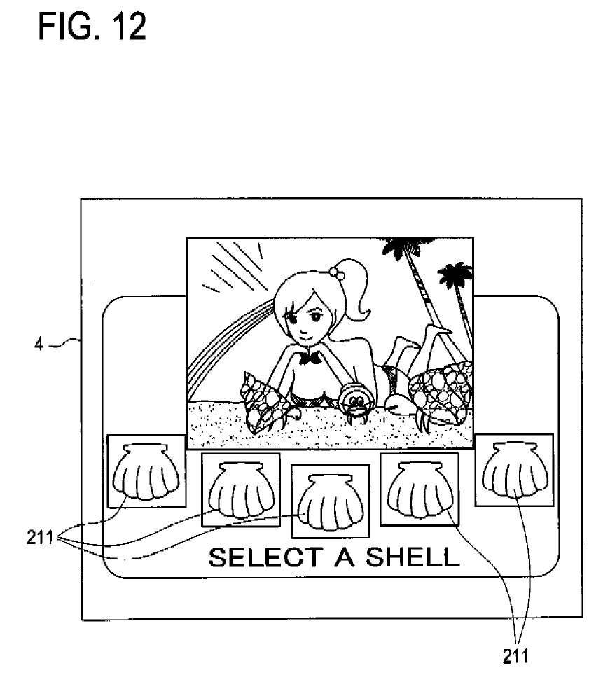

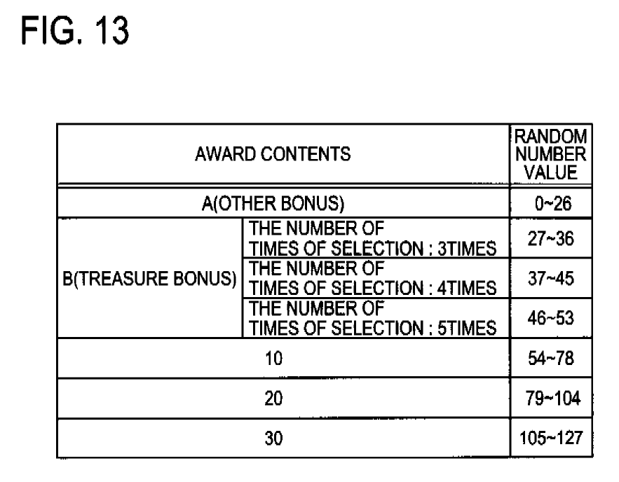

Here, after the procedure is shifted to S12, the CPU 50 determines the award of each of five shells 211 by lottery. Here, in the ROM 51, a content of award lottery table (see FIG. 13) is stored. The CPU 50 determines the award of each of the shell 211 based on the award table and the random number value sampled by the random number sampling circuit 56. For example, in determination for the award of some shell 211, if the random number sampled by the random number sampling circuit 56 lies in a range of “27” to “36”, the shell 211 is associated with “B (the number of times of selection: three times)” as the award based on the award lottery table (see FIG. 13). Each of the awards is determined in the same way based on the sampled random number value and the range which is set every award stored in the award lottery table (FIG. 13). As above, in S12, the random number value is sampled by the random sampling circuit 56 controlled by the CPU 50. The CPU 50 determines the awards of every shell 211 respectively by reference to sampled random number value and the award lottery table (see FIG. 13). After determination the awards of every shell 211, the CPU 50 will shift the procedure to S13.

Next, after the procedure is shifted to S13, the CPU 50 determines whether or not the player selects the shell 211 displayed on the lower display 4 through the touch panel 201. If the selection is done by the player (S13: YES), the CPU 50 will display the arrow indicating the shell 211 selected by the player and will shift the procedure to S14. On the other hand, the selection is not done by the player (S13: NO), the CPU 50 will wait until selection is done by the player.

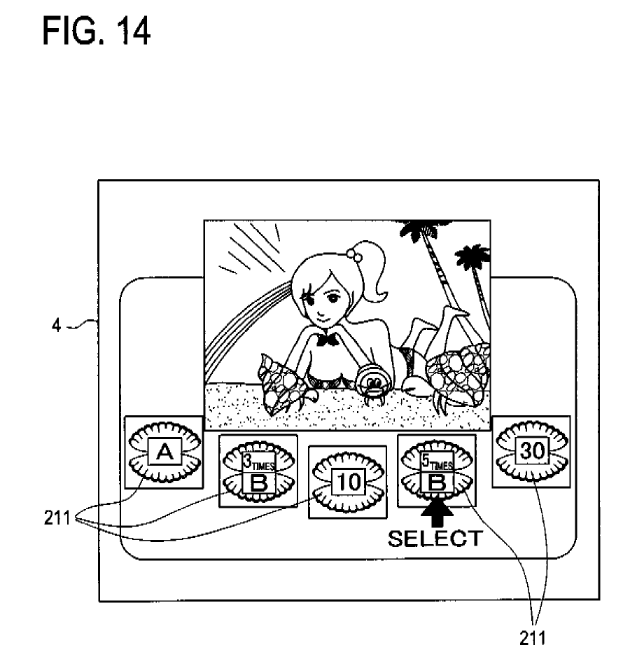

In S14, the CPU 50 displays the awards of five shells 211 on the lower crystal display 4 (see FIG. 14). After displaying the awards of five shells 211, the CPU 50 shifts the procedure to S15. Here, if “B (the number of times of selection: three times)”, “B (the number of times of selection: four times)”, or “B (the number of times of selection: five times)” is displayed as the award of the shell 211, the number indicating the number of times of selection (for example, “three times”, “four times”, or “five times”) will be displayed with “B” indicating the treasure bonus with on shell 211.

Here, in S12 in the shell chance game described above, each award of every shell 211 is respectively determined by lottery independently. However, the award of five shells 211 may be determined so that “A”, “B (the number of times of selection: three times)”, “B (the number of times of selection: four times)”, or “B (the number of times of selection: five times)” is always stored in any of five shells 211 displayed on the lower display 4, In this case, the shell chance game can provide the player to the situation in which the player can select the other game or the treasure bonus game.

After the procedure is shifted to S15, the CPU 50 determines whether or not the award of the selected shell is the “special payout” (namely “10”, “20”, or “30”). If the result of the selection selected by the player is the “special payout” (S15: YES), the CPU 50 will shift the procedure to S19. On the other hand, the result of the selection selected by the player is not the “special payout” (S15: NO), the CPU 50 will shift the procedure to S16.

In S16, the CPU 50 determines whether or not the award of the selected shell is the “treasure bonus”. If the result of the player selection is any of “B (the number of times of selection: three times)”, “B (the number of times of selection: four times)”, or “B (the number of times of selection: five times)”, as the “treasure bonus” (S16: YES), the CPU 50 will shift the procedure to the treasure bonus process (S17). On the other hand, the result of the player selection is not the “treasure bonus”, namely, is the “other bonus” (S16: NO), the CPU 50 will shift the procedure to the other bonus process (S18).

After the procedure is shifted to S17, the CPU 50 processes the treasure bonus process by executing the treasure bonus process program. After the treasure bonus process (S17) is executed, the CPU 50 will shift the procedure to S19.

In S18, the CPU 50 executes the other game process. Here, in the other game process, the other game (for example, the free game) will be done, therefore detailed description thereof will be omitted. After the other bonus game process (S18) executed, the CPU 50 will shift the procedure to S19.

In S19, the CPU 50 executes the payout process. In this process (S19), if the award of the selected shell is the special payout, the CPU 50 will pay the coin (s) corresponding to the special payouts (“10”, “20”, or “30”) of that selected shell. If the procedure is shifted to S19 via the treasure bonus process (S17) or the other game process (S18), the CPU 50 will pay coin (s) corresponding to the payout acquired in the treasure bonus game or the other game process. After the payout process (S19) is finished, the CPU 60 finishes the other game process (S4), and shifts the procedure to the main control process. Here, if the procedure is shifted to the main process program, as shown in FIG. 9, the CPU 50 finished the main process program, and newly starts the main process program.

Next, the treasure bonus process program executed in the treasure bonus process (S17) will be described in detail with reference to drawings, and the outline of the treasure bonus game will be described sequentially.

At first, the outline of the treasure box game will be simply described. If the procedure is shifted to the treasure bonus game, twenty three treasure boxes 301 will be displayed on the lower display 4. The twenty three treasure boxes 301 respectively correspond to the payout be awarded to the player as the award. Therefore, the player can acquire the payout by selecting the treasure box 301 a predetermined number of times in which the number of times of the selection (for example, “three times”, “four times”, or “five times”) is determined by the result of selection in the shell chance game. On the upper display 3, three special boxes 401 are displayed. The special boxes 401 also correspond to the awards, respectively. The treasure boxes 301 correspond to the above payout. Independently, each treasure box 301 may or may not include an option for the player to additionally select a special treasure box 401. Therefore, when the player selects the twenty three treasure boxes 301, the selection of special treasure box 401 is valid by selecting that treasure boxes, so the player can acquire the award of the special treasure box 401 by selecting the special treasure box 401.

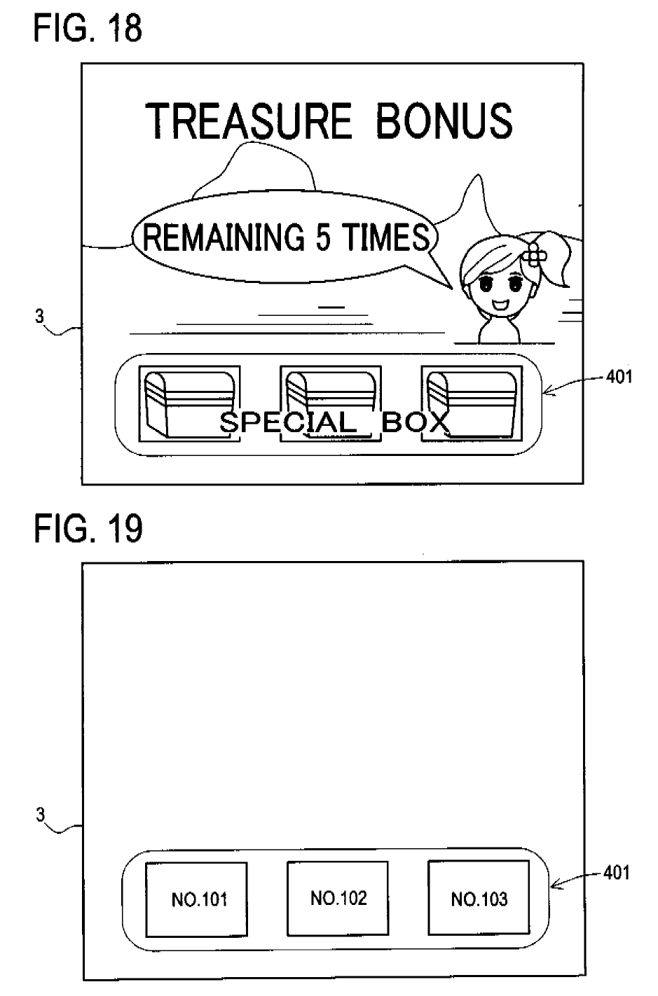

If the procedure is shifted to the treasure bonus process (S17), as shown in the flowchart in FIG. 15, the CPU 50 reads the number of times of selection based on the result of selection in the shell chance game (S21). Next, the CPU 50 displays the twenty three treasure boxes 301 numbered from “No. 1” to “No. 23” on the upper lower crystal display 4, On the upper crystal display 3, the number of times of selection which is read and three special treasure boxes 401, which is numbered from No. 101 to No. 103 (see FIGS. 18 and 19), are displayed. On the lower right screen of the lower display 4, a bet addition operation portion is displayed. The additional bet operating portion 302 is a portion that allows the player to use the player's credit (s) as displayed via the touch panel 201. In the treasure bonus game, the game may operate to allow the player to gradually see more of the potential award while consuming more of the player's credits.

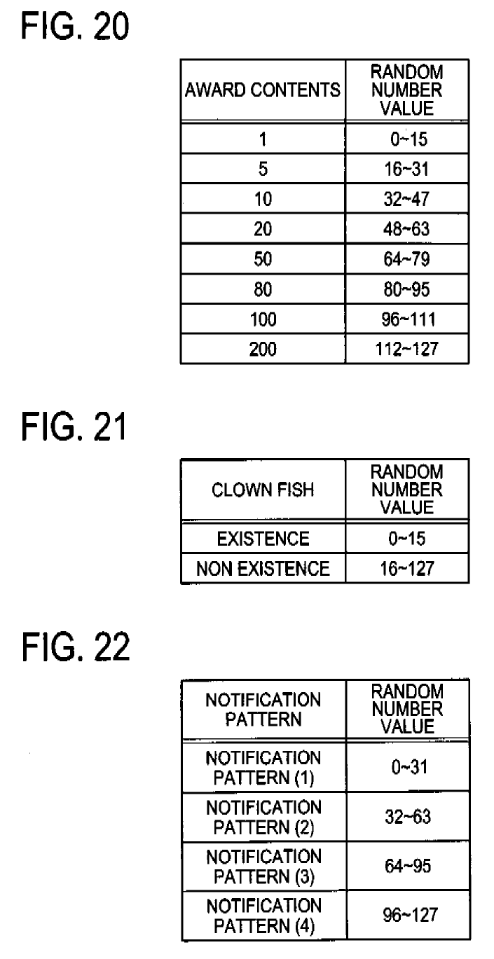

Next, in S22, the CPU 50 determines the award of every treasure boxes 301, and each of the awards corresponds to the treasure boxes 301. Here, concerning with the awards corresponding to that treasure box 301, there are eight kinds including “1”, “5”, “10”, “20”, “50”, “80”, “100”, and “200”. In the ROM 51 in the slot machine 1, the award table is stored. In the award table, the ranges of the random numbers are set respectively corresponding to the eight kinds of award as the payouts. That is, the award based on the random number value is determined by determining the random number value for every treasure box 301 by lottery. Thereby, in S22, the random number values of the treasure boxes 301 is sampled by the random sampling circuit 56, and the awards of the treasure box 301 are determined based on the sampled random number value and the award lottery table (see FIG. 20), controlled by the CPU 50. For example, if the random number value of some treasure box 301 lies in a range of “48” to “63”, the award of that treasure box 301 will be determined “50”. To every twenty three treasure box, the award thereof will be determined in the same way.

Each of twenty three treasure boxes 301 corresponds to the information indicating whether to be valid or not to select the special treasure box 401. In one or more embodiments, the treasure box 301, in which the information indicating to be valid to select the special treasure box 401, corresponds the “CLOWNFISH” symbol 311. Thereby, an existence or nonexistence of the “CLOWNFISH” symbol 311 as the award of the selected treasure box 301 is determined by lottery with the payout. In S22, for every treasure box 301, the existence or nonexistence of the “CLOWNFISH” symbol 311 is determined by lottery in addition to the determination of the awards of the payout. The lottery of the existence of nonexistence is processed based on the sampled random value sampled by the random number sampling circuit 56 and the lottery table as shown in FIG. 21. For example, if the random number value of some treasure box 301 lies in a range of “0” to “15”, the “CLOWNFISH” symbol 311 corresponds to that treasure box 301. In this case, if the player selects that treasure box 301, the “CLOWNFISH” symbol 311 will be displayed and the selection of the special box is valid. After the awards (payouts and the existence or nonexistence of the “CLOWNFISH” symbol) of all treasure box 301 are determined the CPU 50 will shift the procedure to S23.

Next, in S23, the CPU 50 executes the notification pattern determination process. Here, in the notification pattern determination process (S23), an additional bet is made on the basis of the operation of additional bet operating portion 302, and if the treasure box 301 is selected, the notification pattern determination process in which the special content of that treasure box 301 is notified to the player will be processed. In one or more embodiments, there are four kinds of notification pattern including notification pattern (1) to notification pattern (4). Every notification pattern is set the pattern which gradually notifies the player to the award, and differs with one another. Here, the concrete contents of each notification pattern will be described in detail later. Thereby, in S23, the process in which each of the treasure boxes 301 corresponds to one notification pattern is executed. Specifically the notification pattern is determined based on the sampled random value by the random number sampling circuit 56 and the notification pattern lottery table as shown in FIG. 22, controlled by the CPU 50. As shown in FIG. 22, in the notification pattern lottery table, the range of the random numbers are respectively set for each of the notification pattern (1) to notification pattern (4). Thereby, the notification pattern of the treasure box 301 can be determined by determining where the random number value sampled by the random number sampling circuit 56 lies on the range of the random number value. For example, if the random number value of some treasure box 301 lies in a range of “32” to “63”, the notification pattern of that treasure box 301 will be determined “notification pattern (2)”. In this way, the notification patterns of all twenty three treasure box 301 is determined, after that, the CPU 50 will shift the procedure to S24.

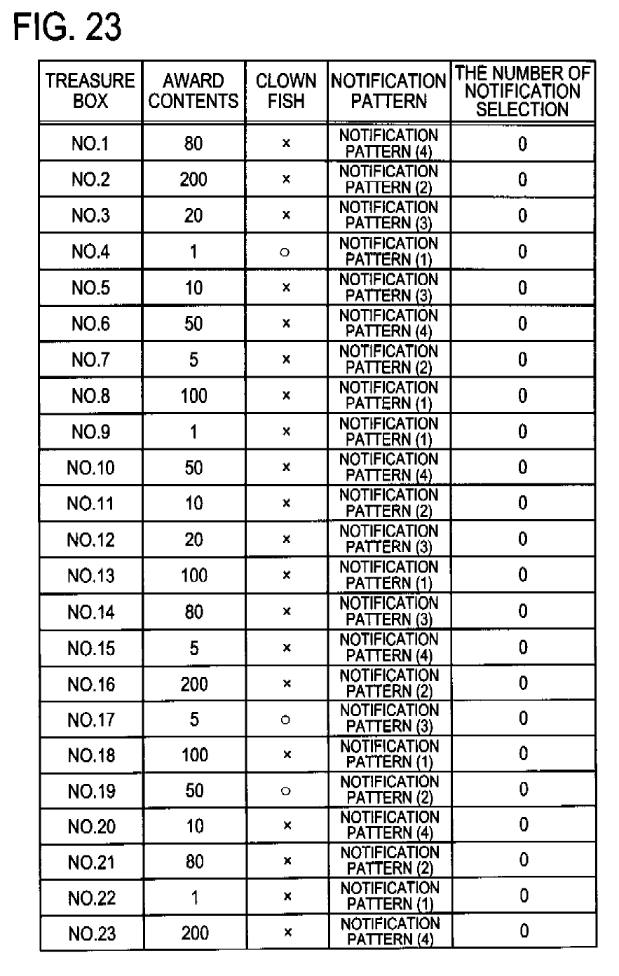

Here, the memory data in when after the process of S21 to S23 stored in the RAM 52 will be described in detail with reference to FIG. 23. As shown in FIG. 23, at the time when S23 is finished, the award of the treasure box 301, the existence or nonexistence of the “CLOWNFISH” symbol 311, and notification pattern are stored every numbers of the treasure box 301. For example, to the treasure box 301 numbered No. 7, as the award, the payout “5”, nonexistence of the “CLOWNFISH”, and the notification pattern (3) are associated. Concerning the numbers of each treasure boxes 301, the frequency in which notification of the award (hereinafter “the number of times of notification selection”) based on the notification pattern of the treasure box 301 is stored. Here, at the time when the procedure of S23 is finished, the notification of the award has not been done yet, so the numbers of notification selection of all treasure boxes 301 are “0”.

The procedure is shifted S24, the CPU 50 determines whether an additional bet is made on the basis of the operation of additional bet operating portion 302 or not. If an additional bet is made (S24. YES), the CPU will shift the procedure to the award notification process (S25). In the award notification process (S25), if the player selects desired treasure box 301, the process in which the award of the selected treasure box 301 is displayed based on the notification pattern of the selected treasure box 301 will be executed. Here, in the award notification process will be described in detail later. After the award of that selected treasure box is displayed based on the notification pattern, the CPU 50 will shift the procedure to S26. On the other hand, if an additional bet is not made (S24: NO), the CPU 50 will directly shift the procedure to S26.

In S26, the CPU 50 determines whether one treasure box out of twenty three treasure boxes 301 displayed on the lower display 4 is selected or not. If the treasure box is not selected (S26: NO), the CPU 50 will return the procedure to S24. Thereby, the player places an additional bet, and then, the award notification process (S25) can be executed. Thereby, the player can acquire the award of another treasure box 301 newly and the player can select the treasure box 301 in a strategic way. On the other hand, if the treasure box is selected (S26: YES), the CPU 50 will subtract 1 from the number of times of selection which is read, after that, subtracted number is restored to the RAM 52 (S27). Next, the number of times of selection displayed on the upper display 3 (see FIG. 18) will be also subtracted. After subtracting to the number of times of selection, the CPU 50 will shift the procedure to S28.

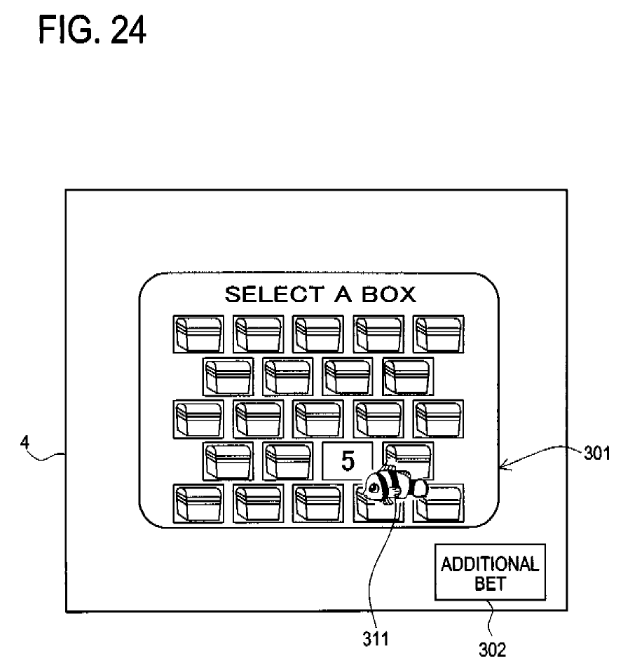

In S28, the CPU 50 displays the award of the selection objective treasure box 301. In one or more embodiments, the image of the selection objective treasure box 301 displayed on the lower display 4 is change to the image indicating the payout number which is the award of the selection objective treasure box and displayed (see FIG. 24). Next, the CPU 50 adds the award (the payout) to the payout of the selection objective treasure box stored in the RAM 52, and stores added payout. Further, the CPU 50 sets the selection of the displayed treasure box, namely, the treasured box in which the content thereof have already been added, for invalidation. After finishing above S28, the CPU 50 shifts the procedure to S29.

The above process will be specifically described. For example, if the player selects the treasure box 301 numbered No. 17 as the selection objective treasure box, the CPU 50 will read the payout “5” as the award corresponding to No. 17 in which the selected treasure box is numbered from the RAM 52 (see FIG. 23). The image of the treasure box 301 numbered No. 17 on the lower display 4 will be changed to the image indicating “5′ in which the award of the treasure box 301 numbered No. 17 (see FIG. 24).

In S29, the CPU 50 determines whether the “CLOWNFISH” symbol 311 corresponds to the selection objective treasure box or not. Specifically, the CPU 50 determines whether or not the “CLOWNFISH” symbol 311 corresponds to the selection objective treasure box with reference to the RAM 52 (see FIG. 23). If the “CLOWNFISH” symbol 311 corresponds to the selection objective treasure box (S29: YES), the CPU 50 will shift the procedure to the special payout awarding process (S30). On the other hand, if the “CLOWNFISH” 311 does not correspond to the selection objective treasure box (S29: NO), the CPU 50 will shift the procedure to S31 directly.

Next, in S31, the CPU 50 determines whether or not the number of times of selection is “0”. If the number of times of selection is “0” (S31: YES), the CPU 50 will finish the treasure bonus process (S17). Here, the award (the payout) acquired in the treasure bonus game will be paid in the payout process (S19) which is executed after the treasure bonus process (S17). On the other hand, if the number of times of selection is not “0” (S31: NO), the CPU 50 will shift the procedure to S24. Here, when the procedure is shifted to S24, the player can continue the treasure bonus game, and can selected the treasure boxes 301 remaining times of the number of times of selection.

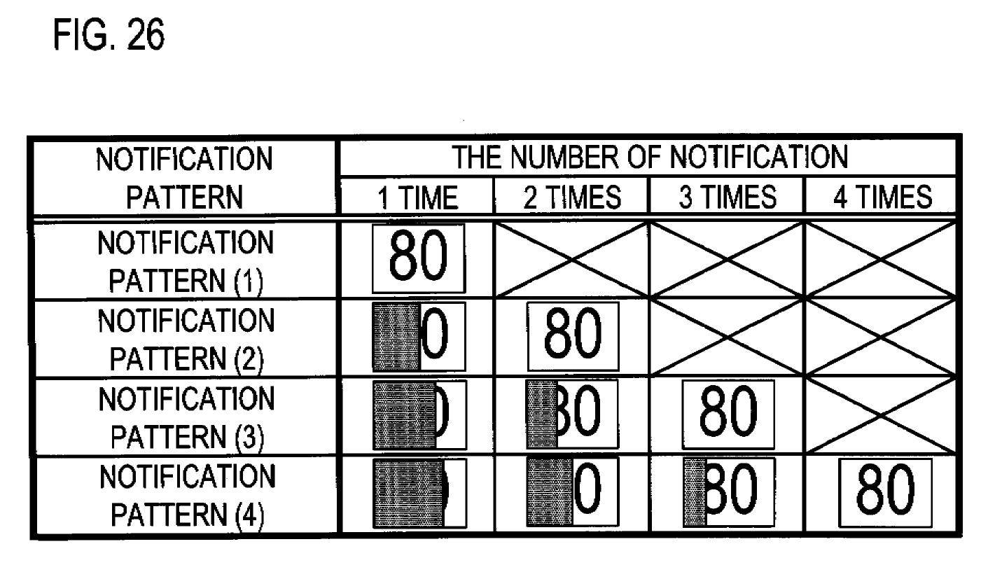

Next, the award notification process in the treasure bonus process (S17) will be described in detail with reference to drawings. At first, the notification pattern corresponding to every treasure box 301 in notification pattern determination process (S23) will be described with reference to FIG. 26. As mentioned above, in one or more embodiments, there are four kinds notification patterns such as notification pattern (1) to notification pattern (4). Each of the notification patterns is set as to gradually notify the award with an increase in the number of times of notification selection. Specifically, as shown in FIG. 26, in the case of the notification pattern (1), when the number of times of notification selection is “1”, the award of the selected treasure box 301 is displayed completely. This is a single stage. In the case of the notification pattern (2), when the number of notification frequency is “1”, the award of the selected treasure box 301 is displayed with right half. When the number of times of notification selection is “2”, the award of the selected treasure box 301 is completely displayed. Notification pattern (2) shows two stages. In the case of the notification pattern (3), the visible portion of the award will be increased in about one-third thereof from the right to the left with an increase in the number of times of notification selection. Thereby, as shown in FIG. 26, it takes three times of notification selection to completely display the award of the treasure box 301 in which the number of times of notification selection “3” is associated. Notification pattern (3) shows three stages. In the case of the notification pattern (4), area of displayed award will be increased in about one-forth thereof from the right to the left with an increase in the number of notification frequency or stages. Thereby, it takes three notification intervals to completely display the award of the treasure box 301 in which the number of times of the notification selection “4” is associated. Notification pattern (4) shows four stages.

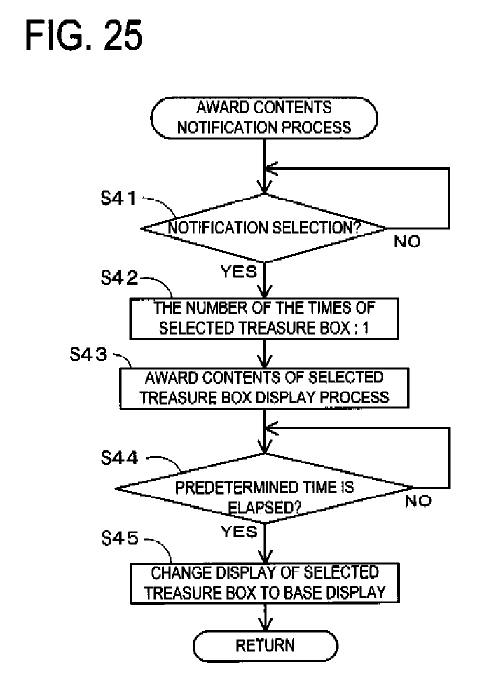

Next, the award notification process program will be described in detail with reference to the FIG. 25. In the treasure bonus process, if the procedure is shift the award notification process on the basis of the operation of additional bet operating portion 302, at first, the CPU 50 will determine whether or not the selection of the treasure box in which the award thereof is notified (hereinafter “notification selection”) is done. If the notification selection is not done (S41: NO), the CPU 50 will wait until the notification selection is done. On the other hand, the notification selection is done (S41: YES), the CPU 50 will shift the procedure to S42.

In S42, the CPU 50 reads the number of times of notification selection for the treasure box 301 which is done the notification selection from the RAM 52, and adds “1” to the number of times of notification selection which is read. Next, the added number is re-stored to the RAM 52. Next, in S43, the CPU 50 executes the award display process for the treasure box 301 done the notification selection based on the number of times of notification selection and the notification pattern of that treasure box 301. As mentioned above, each of the notification patterns is set the display pattern to display the award as to differ with one another with an increase in the number of times of notification selection. Here, in the award display process, the CPU 50 will refer to added number of notification selection for the treasure box 301 in the S42. A notification pattern is determined based on that number of the notification selection and the notification pattern of that treasure box 301 (see FIG. 26). Thereby, the CPU 50 displays the award to notify the player based on the determined notification pattern. For example, when the treasure box 301 in which the notification pattern (4) corresponds has received the notification selection, if the number of times of notification selection is “3”, that treasure box 301 will be displayed with the one-forth hidden image indicating the bonus content thereof (see FIG. 26).

Here, in S43, the display pattern of the award corresponding to that treasure box 301 is changed based on the number of times of notification selection, and the notification pattern. In addition, the more the number of times of notification selection increases, the more the award is displayed definitely. At result, the player is provided more information, so the player can select the treasure box 301 based on the information. Here, notification of the award is performed under the condition in which additional bet is made on the basis of the operation of additional bet operating portion 302. Accordingly, the player may develop an interest in the game such as developing strategy in view of the number of holding credit (s). The award is notified in incremental steps, so the player determines how step the award of the treasure box 301 is displayed in view of the number of holding credit (s). For example, when the part of the award of the treasure box 301 is displayed, the player can guess the award from the partially revealed information. Thereby, the player's guess can help increase the player's interest in the game.

Here, if the”“CLOWNFISH” 311 symbol corresponds to that treasure box 301, the “CLOWNFISH” symbol 311 will be also displayed on the basis of the number of times of notification selection and the notification pattern. For example, if the “CLOWNFISH” symbol 311 corresponds to the treasure box 301 in which notification pattern thereof is the notification pattern (3), and the number of times of notification selection is “1”, the part of the “CLOWNFISH” symbol 311 (for example, fishtail part) is displayed.

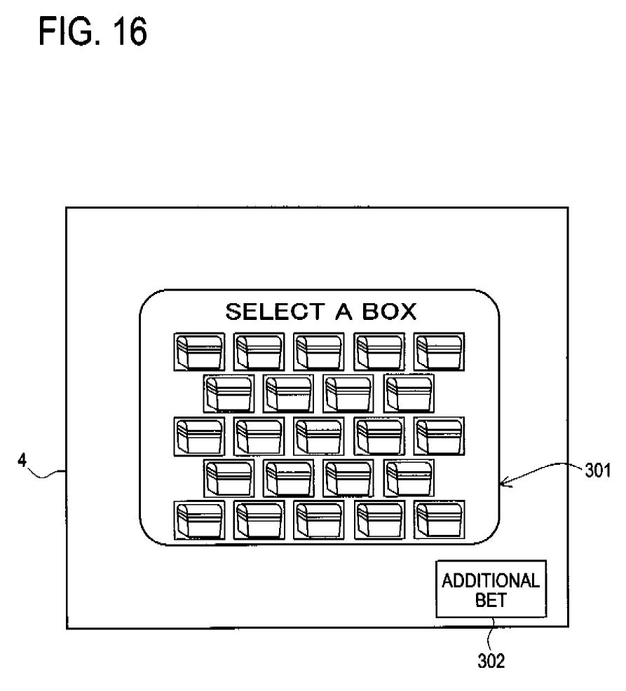

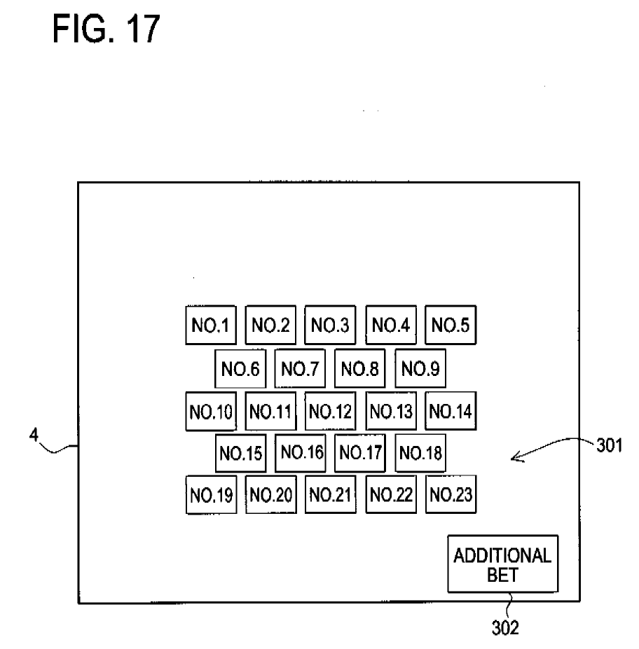

Next, in S44, it is determined whether or not a predetermined time (for example, five seconds) elapses in the award display process, by the CPU 50. If the predetermined time does not elapse (S21: NO), the CPU 50 delays executing the process that modifies the display of the award of that treasure box 301 based on the notification pattern. On the other hand, if the predetermined time elapse (S21: YES) since the award is displayed, the CPU 50 will change the display of the treasure box 301 from display pattern in which based on the notification pattern to the base display pattern (the image of the treasure box as shown in FIG. 16)(S45). After changing the display pattern of the treasure box 301 to the base display pattern, the CPU finishes the award notification process.

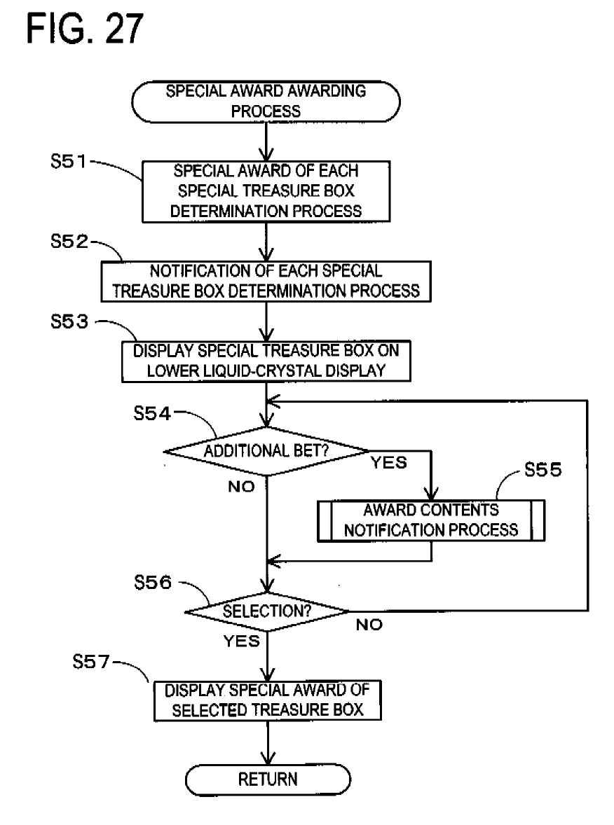

Next, the award awarding process program will be described in detail with reference to drawings FIG. 27 is a flowchart showing the award awarding process program. In the treasure bonus process, if the “CLOWNFISH” 311 symbols corresponds to the treasure box 301 selected by the player (S29: YES), the CPU 50 displays three special treasure box 401, which is displayed on the upper display 3, on the lower display 4, and shifts the procedure to the award awarding process (S30). If the procedure is shifted to the award awarding process (S30), at first, the CPU 50 executes the award determination process (S51) in which the award corresponds to each of three special treasure box 401.

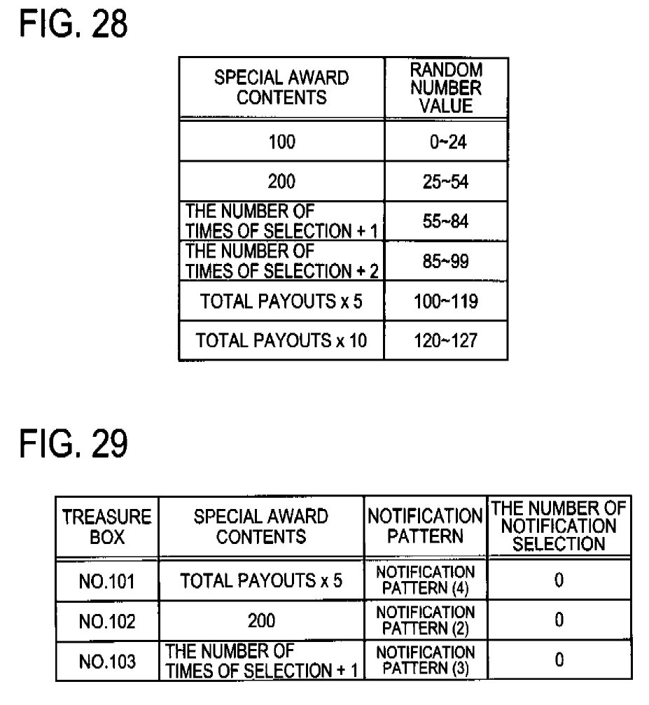

Here, an award lottery table and the content thereof used in the award determination process (S51) will be described in detail with reference to drawing. In one or more embodiments, there may be various kinds of awards including “100”, “200”, “the number of times of selection+1”, “the number of times of selection+2”, “total payouts×2”, and “total payouts×10” (which in at least one example number six awards). The award “100” and “200” are the awards in which “100” and “200” payouts will award to the player. The award “the number of times of selection+1” and “the number of times of selection+2” are the awards in which the number of times of selection will added the predetermined number. The award “total payouts×2”, “total payouts×5” are the awards in which the total bonus will be multiplied by the “5” or “10” when the treasure bonus game is finished. To the award lottery table, the ranges of the random number value corresponding to the each of six awards are set, for example, “55” to “84” corresponds to the award “the number of times of selection+1” (see FIG. 28).

Thereby, in the award determination process (S51), to each of three special treasure box 401 (NO. 101 to NO. 103), the random number value are sampled by the random sampling circuit 56, controlled by the CPU 50. The award of the special treasure box 401 is determined based on the sampled random number value and the award lottery table (see FIG. 8). For example, sampled random number value lies in a range of “100” to “119”, it will be determined that the award of that treasure box 301 is “total payouts×5”, After the award of each three special treasure box (NO. 101 to NO. 103) is determined, the CPU 50 will shift the procedure to S52.

After the procedure is shifted to S52, the CPU 50 executes the notification pattern determination process in which the notification pattern of the special treasure box 301 is determined. Here, in S52, the notification pattern of each treasure box 401 is determined by using the notification pattern lottery table (see FIG. 22) in the same way of the notification process for the treasure box 301 (S23) mentioned above. Thereby, the random value corresponding to each of the special treasure box 401 is sampled, and the notification pattern of the special treasure box 401 is determined based on the sampled random number value and the notification pattern lottery table. After the notification patterns of each special treasure box 401 are determined, the CPU 50 will shift the procedure to S53, When the process of S52 is finished, in the RAM 52, the award, the notification pattern, and the number of times of notification selection are stored corresponding to each number (number 101 to number 103) in the same way of the treasure box 301. For example, in the case as shown in FIG. 29, to the special treasure box 401 numbered “number 101”, the award “total payouts×5” and the notification pattern “notification pattern (4)” are stored. Here, at the time when the process of S52 is finished, each of the number of times of notification selection corresponding to every three special treasure box 401 is also stored as “0”.

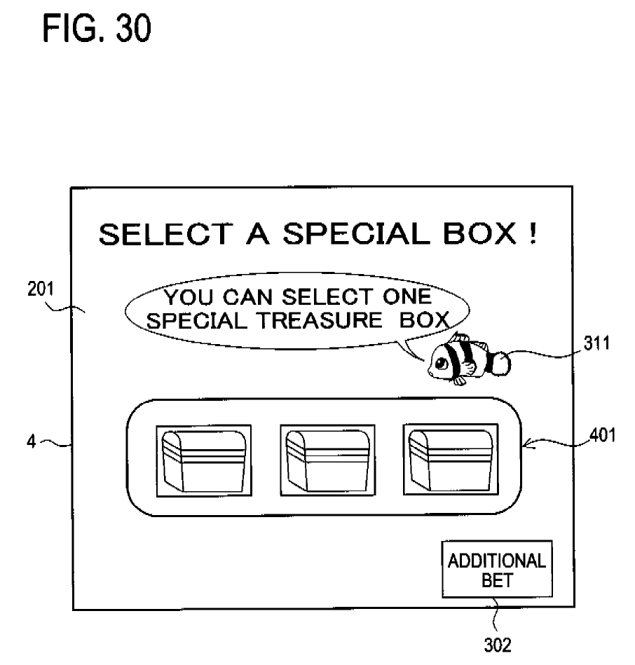

In S53, the CPU 50 displays three special boxes 401 displayed on the upper display 3 on the lower display 4. Then, on the lower display 4, the notice in which the special treasure box 401 is selectable is displayed with three special boxes 401 (see FIG. 30). Thereby, the special treasure box 401 is displayed on the lower display 4 at the result. Here, the player can select the special treasure box 401 by touching the touch panel 201. If the special treasure box 401 is displayed on the lower display 4, on the lower right screen of the lower display 4, the additional bet operating portion 302 will be also displayed. Thereby, the special treasure box 401 is also selectable by operation of additional bet operating portion 302. After the image as shown in FIG. 30 is displayed on the lower display 4, the CPU 50 will shift the procedure to S54.

If the procedure is shifted to S54, the CPU 50 determines whether or not the operation of additional bet operating portion 302 has been selected. If the operation of additional bet operating portion 302 is done (S54: YES), the CPU 50 will shift the procedure to the award notification process (S55) in the same way of the award notification process (S25) as mentioned above. Thereby, the player selects the special treasure box, at a result, the process in which the award of that special treasure box is notified based on the number of times of notification selection and the notification pattern of that special treasure box 401 is executed. Here, details of the award notification process program have been explained above so the explanation of the award notification process (S55) will be omitted. After the process of S55 is finished, the CPU 50 will shift the procedure to S56. On the other hand, the operation of additional bet operating portion 302 is not done (S55: NO), the CPU 50 will shift the procedure to S56 directly.

Here, in the selection of the special treasure box 401, in which, if the treasure box corresponding to the “CLOWNFISH” 311 is selected, the selection of that special treasure box 401 is selectable, the award notification process for the award corresponding to the special treasure box 401 by the operation of additional bet operating portion 302. The award of the special treasure box 301 is also displayed on the basis of the number of times of notification selection and the notification pattern, so the selection of the special treasure box 401 is added to the interest such as strategic characteristics.

In S56, the CPU 50 determines whether or not the selection of the special treasure box 401 is done. If the selection of the special treasure box 401 is done (S56: YES), the CPU 50 will display the special payout of that special treasure box 401, and the content of that special payout is stored in the RAM 52 (S57). After displaying the special award of the selected special treasure box 401 in S56, and storing the contents of the special award, the CPU 50 will finish the award awarding process. On the other hand, if the selection of the special treasure box 401 is not done (S56: NO), the CPU so will return the procedure to S54. Thereby, the award notification process can be executed again. Thereby the selection of the award can be done more strategically in the case that the player can acquire the information of the content of the special award for another special treasure box 401, or the player can acquire the information of the special award of the special treasure box 401 already acquired in the award notification process (S55) in more detail.

As mentioned above in detail, in the slot machine 1 of the embodiment, in the treasure bonus game, the game awarding the award corresponding to the selected treasure box 301 based on that one treasure box 301 is selected among a plurality of the treasure boxes 301. Here, in the selection of the treasure box 301 in the treasure bonus game, if desired selection item (for example, the treasure box 301) is selected on the basis of the operation of additional bet operating portion 302, the award will be displayed. Thereby, the player can recognize what award corresponds to which selection item in the predetermined condition. That is, the player can acquire the information of the award for the selection item (for example, treasure box 301), the selection of selection item elevates the interest to include strategic considerations for the game.

Further, as the award corresponding to the selected treasure box 301, there are some treasure boxes that allow the player to select the special treasure box 401 in which the player cannot select in the base treasure bonus game. This special treasure box 401 respectively corresponds to the special award that is more favorable than the treasure box 301. With the selection of the special treasure box 401, the special award corresponding to the special treasure box 401 is displayed by selecting of the desired special treasure box 401 on the basis of the operation of additional bet operating portion 302. At a result, in the selection of the special treasure box 401, the player can also recognize what award corresponding to which special treasure box 401 in the predetermined condition. Thereby, the selection of the special treasure box awarding the special award that is more favorable than the base treasure bonus game is also increases the player's interest as including strategic considerations to obtain the special treasure boxes 401.

In treasure bonus game above, in the award notification process (S25, S55), the player will be notified of the bonus content for selection item (the treasure box 301 and the special treasure box 401). At this time, in the award notification process (S25, S55), the player will be notified of that content by the display pattern on the basis of the number of times of notification selection corresponding to every selection item (the treasure box 301 and the special treasure box 401) and the notification pattern corresponding to every selection item (the treasure box 301 and the special treasure box 401). Here, the notification pattern gradually notifies the player of the bonus content, so, in the bonus content notification process (S25, S55), the greater number of times of notification selection increases, more of the award is visible to the player. At the result, the player can consider which future steps to take to acquire the information for the award of selection item (treasure box 301 and special treasure box 401). That is, in the treasure bonus game, the level of the acquired information of the award can be a strategic consideration, thereby enhancing a strategic characteristic of the treasure bonus game.

Here, aspects of the present invention are not limited to the above embodiment and various changes and modification can be done within the scope of the present invention. For example, in one or more embodiments, it is constructed that the more the number of times of notification selection increase, the more the award is expanded definitely from the right to the left (see FIG. 26), however, one or more embodiments are not so limited. For example, it may be constructed that the area of displayed award is randomly determined, not always wiping from right to left. Therewith, it allows that the interest as guess for the award of the treasure box 301 is enhanced.

In one or more embodiments, the award notification process by which the award of the treasure box 301 is notified (S25, S55) is executed under the condition for the operation of additional bet operating portion 302. However, another condition may be used. For example, aspects of the invention may include the award process (S25, S55) on the basis of the result of other game (for example, the base game (S3) and other bonus game (s18)).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display device;
a selection device that receives a player's selection of one item among first items displayed on the display device;
an award information memory device that stores award information corresponding to the first items; and
a processor programmed to operate with the display device, the selection device, and the award information memory device (a) to set a notification pattern with one or plural stages corresponding to each of the first items, (b) to permit notification of the award information on a condition that an additional bet is conducted after a game is started, and (c) to notify the award information corresponding to the selected item identified by the selection device according to the notification pattern when the condition is satisfied.

2. The gaming machine according to claim 1, wherein the processor increments a notification count relating to a number of times notification has been provided for the selected item,
the gaming machine further comprising:
a notification pattern memory device that stores plural notification patterns, each notification pattern being set so that the award information becomes gradually visible according to an increase in the notification count;
wherein the processor sets the degree of visibility of the award information for the selected item based on the notification pattern and the notification count.

3. The gaming machine according to claim 2, wherein each notification pattern includes a predetermined number of stages, and
wherein the award information is fully visible when the notification count reaches the predetermined number of stages.

4. The gaming machine according to claim 1, wherein the processor determines a notification pattern associated with the selected item, the notification pattern including a number of stages,
wherein the processor increments a count of a number of times the first selection item has been selected by the player via the selection device;
wherein the processor determines award contents corresponding to each of the first items; and
wherein the display device displays the award contents with an increasing amount of visibility every time the selected item is selected by the player until the count reaches the predetermined number of stages.

5. The gaming machine according to claim 4, wherein the processor determines whether or not a special award is to be given, and
wherein the display device displays plural second items thereon when the processor determines that the special award is to be given.

6. The gaming machine according to claim 5, wherein the display device has a first display screen and a second display screen, and
wherein the first items are displayed on the first display screen and the second items are displayed on the second display screen.

7. The gaming machine according to claim 5, wherein, when the processor permits notification of the award information, the processor notifies special award information corresponding to the second item selected by the player via the selection device.

8. A gaming machine comprising:
a display device, and
a processor that receives a first input instruction and a second input instruction, the first input instruction relating to a player's selection of one selection item among first items displayed on the display, and the second input instruction relating to the player initiating a notification of award information,
wherein the processor accesses a notification pattern table that stores notification patterns relating a visible portion of the award information to be displayed based on a number of times that an instruction has been received from an instruction device and an award information data table that, for each of the first items associates award information and one of the notification patterns,
wherein the processor is configured to operate with the display device (a) to consume a credit, (b) to determine the award information and the notification pattern corresponding to the selected one selection item by referring to the notification pattern table, (c) to increment a count of the number of times of the second input instruction for each selected one selection item, and (d) to adjust the visible portion of the award information according to the count and the notification pattern.

9. A gaming machine comprising:
a display device;
a selection device that receives a selection of one selection item among first items displayed on the display device;
an award information memory device that stores award information corresponding to the selected first item; and
a processor programmed to operate with the display device, the selection device, and the award information memory device to provide information relating to the award information to a player.

10. The gaming device according to claim 9, the processor configured to provide the information relating to the award information corresponding to each of the first selection items to the player via a notification pattern with one or more stages.

11. The gaming device according to claim 10, the processor further configured to provide the notification pattern on at least one condition for a player.

12. The gaming device according to claim 11, wherein the at least one condition is that an additional bet will be placed after the game is started.

13. The gaming device according to claim 9, where the processor is a hardware processor.

14. The gaming device according to claim 9, where the processor is a JAVA-based application running on a player's computer.

15. A system for providing award information to a player during a gaming session:
an award information memory device that stores award information corresponding to an item selected by a player; and
a processor that receives the award information from the award information memory device, the processor being programmed to output information relating to the award information to the player, the information relating to the award information being output for display on a display device.

16. The system according to claim 15, the processor being configured to provide the information relating to the award information to the player in a notification pattern with one or more stages corresponding to each of the first selection items.

17. The system according to claim 16, the processor further configured to provide the notification pattern once the player has accepted a condition.

18. The system according to claim 17, wherein the condition is that an additional bet will be placed after the gaming session has started.

19. A method for providing award information to a player during a gaming session:
receiving award information from a memory device, the award information corresponding to an item selected by a player, the item being selected during the gaming session;
receiving an indication of the item selected by the player; and
outputting to the player information corresponding to the item selected, the information relating to the award information.

20. The method according to claim 19, wherein the outputting the information relating to the award information provides the information in a notification pattern with one or more stages corresponding to each of the first selection items.

21. The method according to claim 20, the processor further configured to provide the notification pattern once the player has accepted a condition.

22. The method according to claim 21, wherein the condition is that an additional bet will be placed after the gaming session has started.
